(19) United States
(12) Patent Application Publication
(10) Pub. No.: US 2019/0337140 A1
(43) Pub. Date: Nov. 7, 2019

(54) SPIN WRENCH

(71) Applicant: Christian Shanklin, Peru, IL (US)

(72) Inventor: Christian Shanklin, Peru, IL (US)

(21) Appl. No.: 15/969,636

(22) Filed: May 2, 2018

(51) Int. Cl. B25G 1/00; B25B 13/46; B25G 1/04; B25B 23/00

(52) U.S. Cl. CPC B25G 1/007; B25B 23/0035; B25G 1/043; B25B 13/462

(57) ABSTRACT

A standard ratchet wrench assembly having a handle socket member adapted to removably receive a ratchet drive extension member therein, such that a user can use the ratchet drive extension member to increase the moment force upon said standard ratchet wrench assembly when in use.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of wrench devices and more specifically relates to a standard ratchet wrench assembly having a handle socket member adapted to removably receive a ratchet drive extension member therein, such that a user can use the ratchet drive extension member to increase the moment force upon the standard ratchet wrench assembly when in use.

### 2. Description of the Related Art

A socket wrench is a type of wrench or spanner that has a socket attached at one end, usually used to turn a fastener. The most prevalent form is the ratcheting socket wrench, often informally called a ratchet. A ratcheting socket wrench is the device within a hand tool in which a metal handle is attached to a ratcheting mechanism, which attaches to a socket, which in turn fits onto a type of bolt or nut.

Pulled or pushed in one direction, the ratchet loosens or tightens the bolt or nut attached to the socket. Turned the other direction, the ratchet does not turn the socket but allows the ratchet handle to be re-positioned for another turn while staying attached to the bolt or nut. This ratcheting action allows the fastener to be rapidly tightened or loosened in small increments without disconnecting the tool from the fastener. A switch is built into the ratchet head that allows the user to apply the ratcheting action in either direction, as needed, to tighten or loosen a fastener. Other common methods of driving socket wrenches include pneumatic impact wrenches, hydraulic torque wrenches, torque multipliers and breaker bars. Some lesser known hybrid drivers include striking wrench tools with square drive, and hydraulic impact wrenches (typically powered by on site hydraulic power such as present with military tanks, and many rail car applications).

Socket wrenches are most commonly hexagonal, or more commonly referred to as “6-point” in lay terms. Sockets are driven by being attached to the driving tool via a male/female square connection fitting (called the square drive). Standard sizes of square drives around the world include ¼″, ⅜″, ½″, ¾″, 1″, 1½″, 2½″ and 3½″ square drive sizes (a de facto international standard with no metric equivalents along with some lesser used drivers such as ⅝″ square drive, and both #4 and #5 spline drives specified in ANSI B107 specifications. This wide range of square drive sizes provides for a wide variety of socket types and sizes to suit small to very large nuts and bolts. Some square drivers have a through hole to attach the socket to the driver (using a retaining ring with o-ring and pin type, or single piece molded retaining rings), a locking pin, or friction ball. Some common hand ratchets employ a quick release button on their top for quick socket release of smaller sockets.

The tool chosen to drive the socket wrench ultimately supplies the mechanical advantage needed by the user to provide the torque needed to loosen or tighten the fastener as may be required. Larger drivers are typically used with higher torque, while smaller drivers are used for convenience in smaller low torque applications. Given the limits of human strength and fatigue, torque above 600 ft-lbs of torque will generally involve some kind of power assist, instead of the user simply pushing on the handle of a wrench. Very large sockets and drivers are typically powered by hydraulics to achieve torque.

A socket is typically a cylinder which has a female six- or twelve-point recessed opening sized to fit over the common male hexagonal head of a bolt or nut fastener. The opposite end of the socket wrench has a standardized (ANSI B107, ISO, or other consensus standard) square recess to accept the socket wrench's drive size. Male drivers are also produced for use with socket head cap screws, and are often called Allen drivers (trademark) or the generic term male bit drivers.

The principal advantage of interchangeable sockets is that, instead of a separate wrench for each of the many different fastener sizes and types, only separate sockets are needed for each size and type. Because of their versatility, nearly all screw and bolt types now have sockets of different types made to fit their bolts or nuts. Sockets often come as a “socket set” with many different sizes or types of sockets to fit the heads of different-sized fasteners.

Unfortunately, existing wrenches lack both the ability to be used as a crank and to be stored on a workstation pegboard for easier access. Therefore, a need exists for a tool that gives a user the option of operating the wrench with a spindle attachment making tightening and loosening nuts or bolts easier and faster, and have the ability to be hung and stored.

Various attempts have been made to solve the above-mentioned problems such as those found in U.S. Pat. No. 4,104,935 to Roscoe D. Stoops; U.S. Publication Number 2004/0025649 to Frederick Rugee; U.S. Publication Number 20160318170 to Gerald Shane Mulligan; U.S. Publication Number 20040055428 to Donald Cooper; and U.S. Pat. No. 6,308,596 to Elden Williams. This art is representative of torque enhancing devices for wrenches. None of the above inventions and patents, taken either singly or in combination, is seen to describe the invention as claimed.

Ideally, a standard ratchet wrench assembly should be user-friendly and safe in-use and, yet should operate reliably and be manufactured at a modest expense. Thus, a need exists for a standard ratchet wrench assembly having a handle socket member adapted to removably receive a ratchet drive extension member therein, such that a user can use the ratchet drive extension member to increase the moment force upon the standard ratchet wrench assembly when in use and to avoid the above-mentioned problems.

### BRIEF SUMMARY OF THE INVENTION

In view of the foregoing disadvantages inherent in the known wrench device art, the present invention provides a Standard Ratchet Wrench Assembly (Entitled Spin Wrench). The general purpose of the present invention, which will be described subsequently in greater detail is to provide a standard ratchet wrench assembly having a handle socket member adapted to removably receive a ratchet drive extension member therein, such that a user can use the ratchet drive extension member to increase the moment force upon the standard ratchet wrench assembly when in use.

In a standard ratchet wrench assembly having a handle portion and a head portion located on a distal end portion thereof, and wherein the head portion includes a ratchet socket member therein, the improvement comprising a handle socket member. The handle socket member is located within a proximal end portion of the handle member. The handle socket member is adapted to rotate within the proximal end portion of the handle member. The handle socket member is adapted to removably receive a ratchet drive extension member therein, such that a user can use the ratchet drive extension member to increase the moment force upon the standard ratchet wrench assembly when in use.

The present invention holds significant improvements and serves as a Standard Ratchet Wrench Assembly (Entitled Spin Wrench). For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a Standard Ratchet Wrench Assembly (Entitled Spin Wrench), constructed and operative according to the teachings of the present invention.

FIG. 1 shows a perspective view illustrating a handle socket member Standard Ratchet Wrench according to an embodiment of the present invention.

FIG. 2 shows a perspective view illustrating a rotating square member on the handle socket member of Standard Ratchet Wrench according to an embodiment of the present invention.

FIG. 3 shows a perspective view illustrating the handle socket member of the Standard Ratchet Wrench according to an embodiment of the present invention.

FIG. 4 shows a perspective view illustrating the Standard Ratchet Wrench in an in-use condition according to an embodiment of the present invention.

The various embodiments of the present invention will hereinafter be described in conjunction with the appended drawings, wherein like designations denote like elements.

### DETAILED DESCRIPTION

As discussed above, embodiments of the present invention relate to a wrench device and more specifically relates to a standard ratchet wrench assembly having a handle socket member adapted to removably receive a ratchet drive extension member therein, such that a user can use the ratchet drive extension member to increase the moment force upon said standard ratchet wrench assembly when in use.

Generally speaking, the Spin Wrench comprises a modified wrench improving the original use of the wrench tool. A hole is casted onto the handle of the wrench, and a free rotating socket is pressed into position in the hole. It is used like a crank, rotating on an axis. A regular socket wrench has a detachable socket at one end designed to tighten and loosen nuts and bolts of particular sizes. A ratchet wrench works as a tool used to apply torque to specific fasteners, nuts, and bolts. The Spin Wrench is designed to work as a double-sided wrench where one side uses a standard drive extension and a socket to fasten nuts and bolts, and the other side uses a standard drive extension to apply torque to certain fasteners and screws.

### What Problem(s) Does It Solve?

The unique features of this product provide the following benefits for people everywhere.
Gives the user the option of operating both ends of the wrench to tighten and loosen nuts and bolts with lengthy threads easier and faster.
Doubles the function of the existing drive attachments, increasing the wrench's utility.
The socket in the wrench handle gives it a unique ability to be stored in a hanging position for quick and easy access.

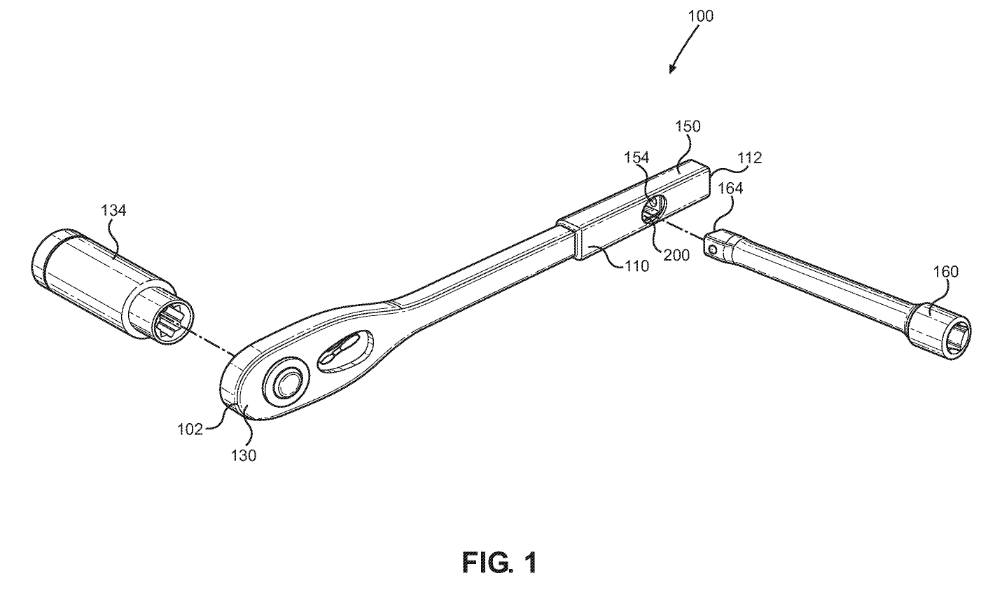

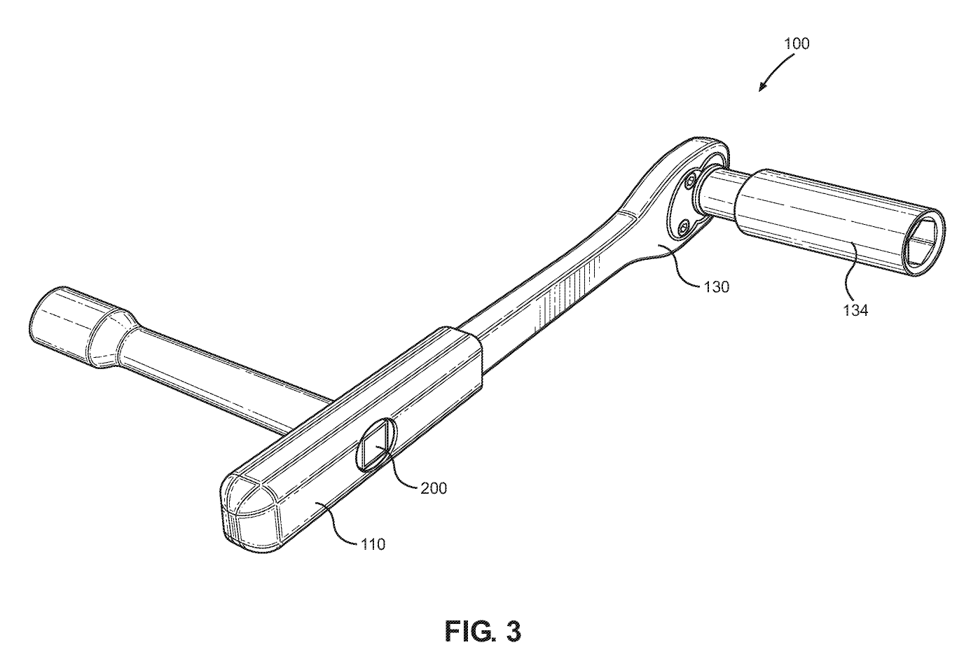

Referring now to FIGS. 1-3, showing perspective views illustrating handle socket member 150 of a standard ratchet wrench assembly 100 according to an embodiment of the present invention of FIG. 1.

In standard ratchet wrench assembly 100 having handle portion 110 and head portion 130 located on distal end portion 102 thereof, and wherein head portion 130 includes ratchet socket member 134 therein, improvement comprising handle socket member 150. Handle socket member 150 is located within proximal end portion 112 of handle member 110. Handle socket member 150 is adapted to rotate within proximal end portion 112 of handle member 110.

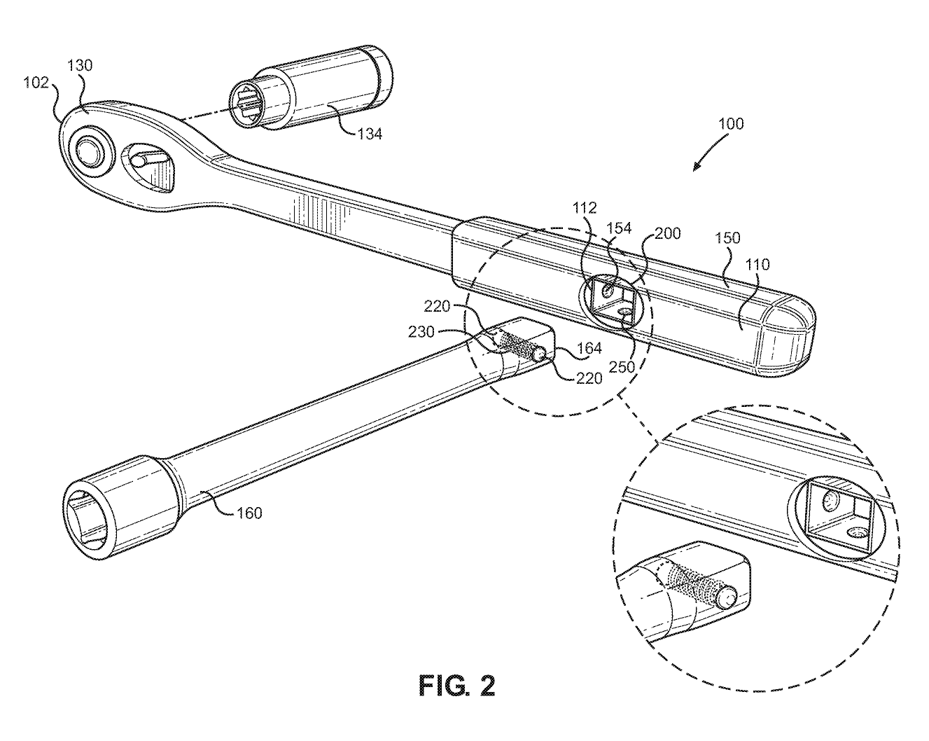

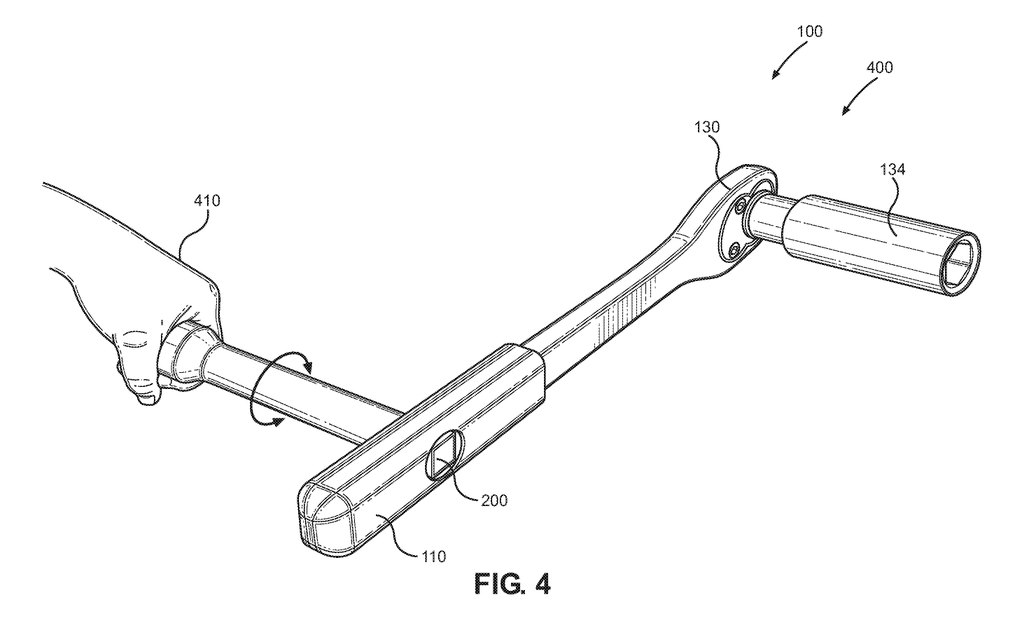

Handle socket member 150 is adapted to removably receive ratchet drive extension member 160 therein, such that user 410 can use ratchet drive extension member 160 to increase the moment force upon standard ratchet wrench assembly 100 when in use as shown in in-use condition 400 of FIG. 4. Wherein handle socket member 150 includes rotating square member 200 adapted to releasably connect with square end portion 164 of ratchet drive extension member 160 as shown in FIG. 2. Standard ratchet wrench assembly improvement 100 further comprising ratchet drive extension member 160 having square end portion 164 adapted to removably connect with rotating square member 200 of handle socket member 150, such that user 410 can use ratchet drive extension member 160 to increase the moment force upon standard ratchet wrench assembly 100 when in use.

Standard ratchet wrench assembly improvement 100, further comprising ratchet drive extension member 160 having end portion 164 adapted to removably connect with handle socket member 150, such that user 410 can use ratchet drive extension member 160 to increase the moment force upon standard ratchet wrench assembly 100 when in use. Wherein end portion 164 of ratchet drive extension member 160 includes at least one ball member 220 and at least one spring member 230 therein, such that end portion 164 is removably connected with handle socket member 150 via at least one ball member 220.

Wherein handle socket member 150 includes plurality of ball bearings 154 adapted to engage proximal end portion 112 of handle member 110, such that handle socket member 150 is freely rotatable within proximal end portion 112 of handle member 110. Standard ratchet wrench assembly improvement 100 further comprises ratchet drive extension member 160 having square end portion 164 adapted to removably connect with said rotating square member 200 of handle socket member 150, such that user 410 can use ratchet drive extension member 160 to increase the moment force upon standard ratchet wrench assembly 100 when in use.

Wherein end portion 164 of ratchet drive extension member 160 includes at least one ball member 220 and at least one spring member 230 therein, such that end portion 164 is removably connected with handle socket member 150 via said at least one ball member 220. Wherein handle socket member 150 includes at least one ball receiving portion 250 adapted to receive a biased ball member 220 of end portion 164 of ratchet drive extension member 160, to thereby be adapted to removably connected with ratchet drive extension member 160.

Wherein handle socket member 150 includes rotating square member 200; wherein at least one ball receiving portion 250 is located upon rotating square member 200; and wherein end portion 162 of ratchet drive extension member 160 is formed having a square shape adapted to fit within rotating square member 200 of handle socket member 150. Wherein rotating square member 200 includes a plurality of ball bearings 206 adapted to engage proximal end portion 112 of handle member 110, such that handle socket member 150 is freely rotatable within proximal end portion 112 of handle member 110

Wherein handle socket member 150 includes two ball receiving portions 250; and wherein end portion 164 of ratchet drive extension member 160 includes two ball members 220 each adapted to removably engage with a respective one of two ball receiving portions 250 of handle socket member 150.

Wherein ratchet drive extension member 160 is formed from a material chosen from a group of materials consisting of forged steel, aluminum, and ceramic. Wherein handle socket member 150 is formed from a material chosen from a group of materials consisting of forged steel, aluminum, and ceramic.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. In a standard ratchet wrench assembly having a handle portion and a head portion located on a distal end portion thereof, and wherein said head portion includes a ratchet socket member therein, the improvement comprising:
a handle socket member;
wherein said handle socket member is located within a proximal end portion of said handle member;
wherein said handle socket member is adapted to rotate within said proximal end portion of said handle member; and
wherein said handle socket member is adapted to removably receive a ratchet drive extension member therein, such that a user can use said ratchet drive extension member to increase the moment force upon said standard ratchet wrench assembly when in use.

2. The standard ratchet wrench assembly improvement of claim 1, further comprising a ratchet drive extension member having an end portion adapted to removably connect with said handle socket member, such that a user can use said ratchet drive extension member to increase the moment force upon said standard ratchet wrench assembly when in use.

3. The standard ratchet wrench assembly improvement of claim 1, wherein said handle socket member includes a rotating square member adapted to releasably connect with a square end portion of a ratchet drive extension member.

4. The standard ratchet wrench assembly improvement of claim 3, further comprising a ratchet drive extension member having a square end portion adapted to removably connect with said rotating square member of said handle socket member, such that a user can use said ratchet drive extension member to increase the moment force upon said standard ratchet wrench assembly when in use.

5. The standard ratchet wrench assembly improvement of claim 2, wherein said end portion of said ratchet drive extension member includes at least one ball member and at least one spring member therein, such that said end portion is removably connected with said handle socket member via said at least one ball member.

6. The standard ratchet wrench assembly improvement of claim 4, wherein said end portion of said ratchet drive extension member includes at least one ball member and at least one spring member therein, such that said end portion is removably connected with said handle socket member via said at least one ball member.

7. The standard ratchet wrench assembly improvement of claim 1, wherein said handle socket member includes at least one ball receiving portion adapted to receive a biased ball member of an end portion of a ratchet drive extension member, to thereby be adapted to removably connected with said ratchet drive extension member.

8. The standard ratchet wrench assembly improvement of claim 5, wherein said handle socket member includes at least one ball receiving portion adapted to receive said biased ball member of said end portion of said ratchet drive extension member to thereby be adapted to removably connect with said ratchet drive extension member.

9. The standard ratchet wrench assembly improvement of claim 8, wherein said handle socket member includes a rotating square member; wherein said at least one ball receiving portion is located upon said rotating square member; and wherein said end portion of said ratchet drive extension member is formed having a square shape adapted to fit within said rotating square member of said handle socket member.

10. The standard ratchet wrench assembly improvement of claim 8, wherein said handle socket member includes two ball receiving portions; and wherein said end portion of said ratchet drive extension member includes two ball members each adapted to removably engage with a respective one of said two ball receiving portions of said handle socket member.

11. The standard ratchet wrench assembly improvement of claim 1, wherein said handle socket member includes a plurality of ball bearings adapted to engage said proximal end portion of said handle member, such that said handle socket member is freely rotatable within said proximal end portion of said handle member.

12. The standard ratchet wrench assembly improvement of claim 3, wherein said rotating square member includes a plurality of ball bearings adapted to engage said proximal end portion of said handle member, such that said handle socket member is freely rotatable within said proximal end portion of said handle member.

13. The standard ratchet wrench assembly improvement of claim 12, further comprising a ratchet drive extension member having a square end portion adapted to removably connect with said rotating square member of said handle socket member, such that a user can use said ratchet drive extension member to increase the moment force upon said standard ratchet wrench assembly when in use.

14. The standard ratchet wrench assembly improvement of claim 1, wherein said handle socket member is formed from a material chosen from a group of materials consisting of forged steel, aluminum, and ceramic.

15. The standard ratchet wrench assembly improvement of claim 2, wherein said ratchet drive extension member is formed from a material chosen from a group of materials consisting of forged steel, aluminum, and ceramic.
